(19) United States
(12) Patent Application Publication
(10) Pub. No.: US 2005/0145461 A1
(43) Pub. Date: Jul. 7, 2005

(54) Clutch of a twain engine remote control automobile

(76) Inventor: Chao-Chuan Wu, Taipei city (TW)

Correspondence Address: BIRCH STEWART KOLASCH & BIRCH, PO BOX 747, FALLS CHURCH, VA, 22040-0747, US

(21) Appl. No.: 10/749,372

(22) Filed: Jan. 2, 2004

(51) Int. Cl. F16D 43/24

(52) U.S. Cl. 192/105 CD

(57) ABSTRACT

A clutch of a twain engine remote control automobile comprising a flywheel stand on the rolling axis of the engine, some clutch parts are installed on the flywheel stand and have a hood covers these clutch parts; the hood consists of a first hood and a second hood, a protruding wheel is on the first hood, a stopper corresponding to the protruding wheel is on the second hood. When both sides the passive gear is brought by two co-axial gears, the protruding wheel makes the two co-axial gears run synchronously.

### BACKGROUND OF THE INVENTION

I. Field of the Invention

This invention relates generally to a cutch of an automobile and, more specifically, to a clutch of a twain engine remote control automobile that has a flywheel stand on the turning axis of the engine, several clutch components are on the flywheel stand and covered with a hood, the hood consists of a first hood and a second hood, a protruding wheel is on the first hood, a stopper is on the second hood, when the passive gear is brought by two co-axial gears, the protruding wheel makes the two co-axial gears run synchronously.

II. Description of the Prior Art

Heretofore, it is known that a clutch of a remote control automobile, as shown in FIG. 9, is to have a flywheel stand 60 of a horizontal turning axis 51 of the engine 50, a clutch set 70 is in front of the flywheel stand 60, the clutch set 70 is a fundamental and common usage structure.

A front hood 71 covers the clutch set 70 and is fixed on the flywheel stand 60, when the turning axis 51 of the engine 50 turns fast along with the flywheel stand 60, the clutch set 70 opens by centrifugal force.

However when the known engine is applied on the twain engine as shown in FIG. 7, the defects appear as following:

Referring to FIG. 10, two engines 50 with same specification with similar maximum speed, however when they start running, the acceleration within the same definite time will not be the same, therefore when two engines 50 drive the same passive gear 80 with different speed will introduce interference, not only the transmission is not smooth but might cause damage to the gears, the horizontal turning axis 81 inside the engines 50 might be broken by the deflection, the known engines 50 apply the clutch described above, the usage life will reduced, this condition is a bottleneck of technology with proper solution.

### SUMMARY OF THE INVENTION

It is therefore a primary object of the invention to provide a clutch of a twain engine remote control automobile to adjust two engines run asynchronously initially, the two co-axial gears can coordinate with each other and drive the passive gear synchronously, the mechanism is safer to extend engines' life also reduce the failure rate for lower cost.

In order to achieve the objective set forth, a clutch of a twain engine remote control automobile in accordance with the present invention comprises a flywheel stand on the rolling axis of the engine, some clutch parts are installed on the flywheel stand and have a hood covers these clutch parts; the hood consists of a first hood and a second hood, the first hood has a containing space on the rear to contain and isolate the clutch parts, a protruding ring is on the front of the first hood, an axis hole for the turning axis to pass through is on the center of the protruding ring, at least one side slots around the protruding ring; a protruding wheel with one side to swing is inside the side slot; the second hood has a center hole and a container corresponding to the first hood to cover the protruding ring and other components, a stopper is on the inner circumference of the container of the second hood, two co-axial gears are in the front of the second hood; a fixing mechanism is inserted from the front, passing through the axis hole and the center hole of the first hood and the second hood and fixed on the turning axis of the engine.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the present invention;

FIG. 2 is a perspective view of an embodiment of the present invention;

FIG. 3 is a perspective view from another angle of an embodiment of the present invention;

FIG. 4 is an assembly view of another application of the present invention;

FIG. 5 is an application view of an embodiment of the present invention;

FIG. 6 is another application view of an embodiment of the present invention;

FIG. 7 is a perspective view of an embodiment of the present invention;

FIG. 8 is the description of the present invention;

FIG. 9 is a perspective view of the prior art;

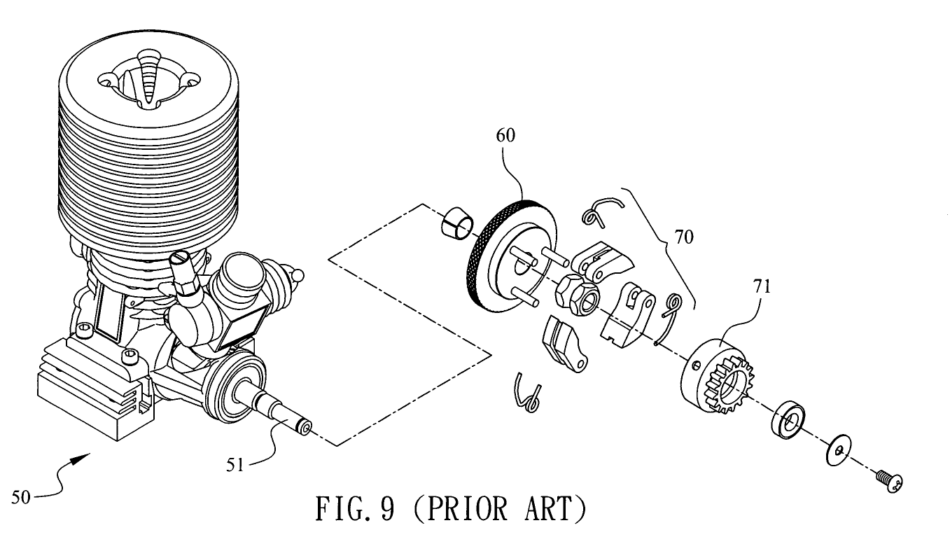

FIG. 10 is an application view of an embodiment of the prior art.

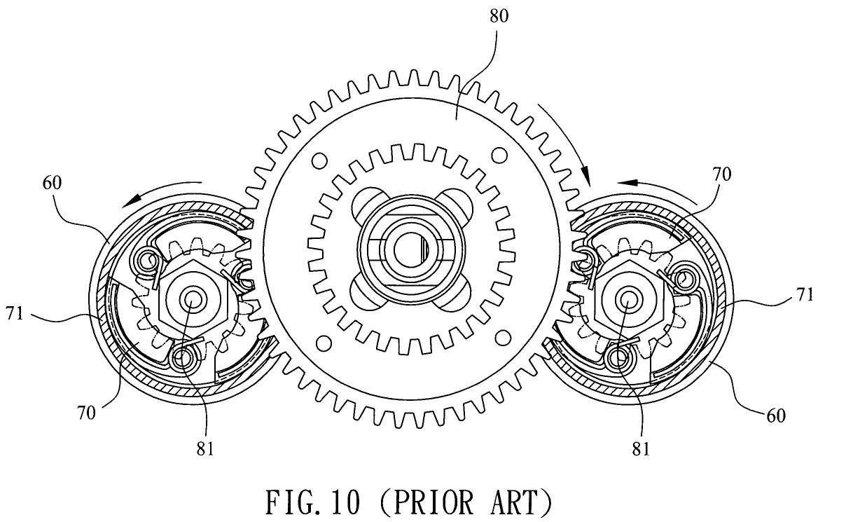

### DESCRIPTION OF THE PREFERRED EMBODIMENT

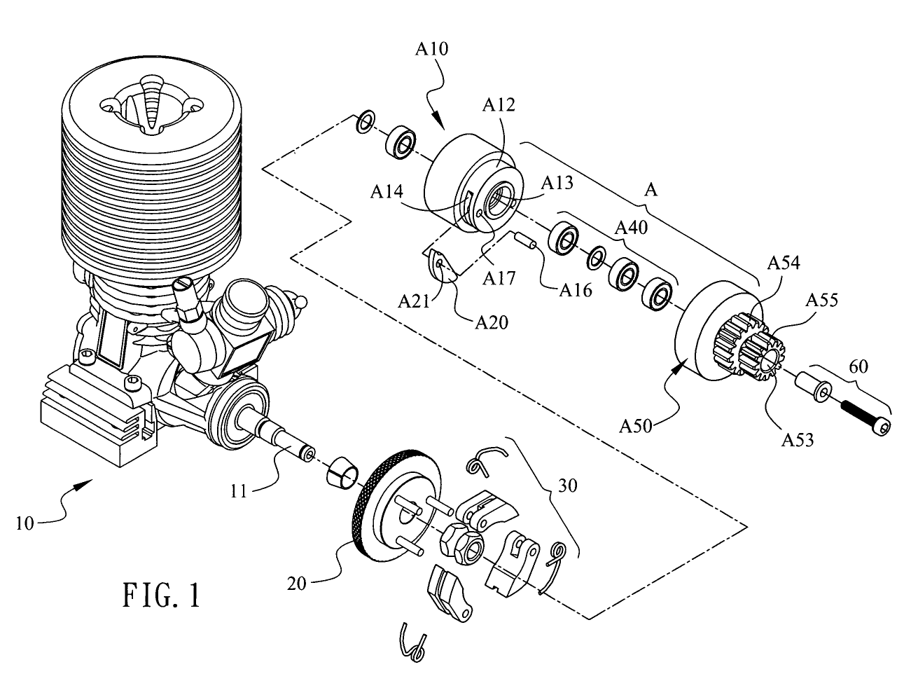

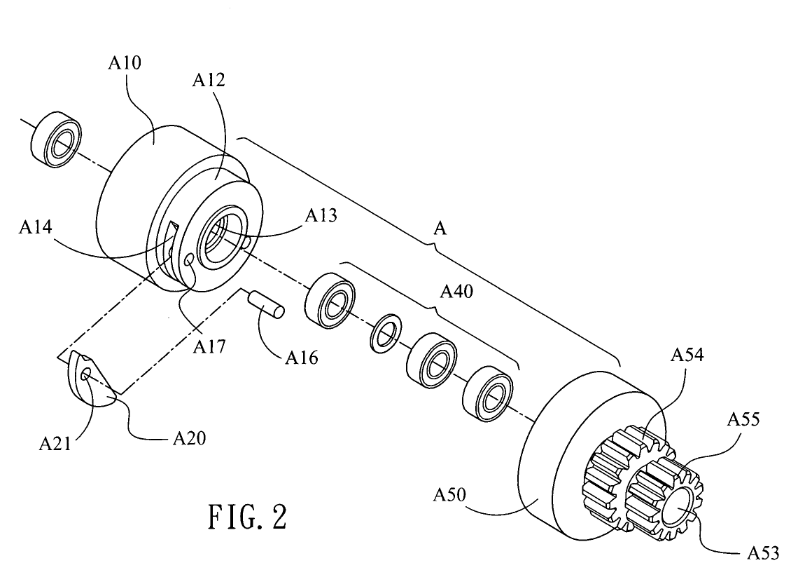

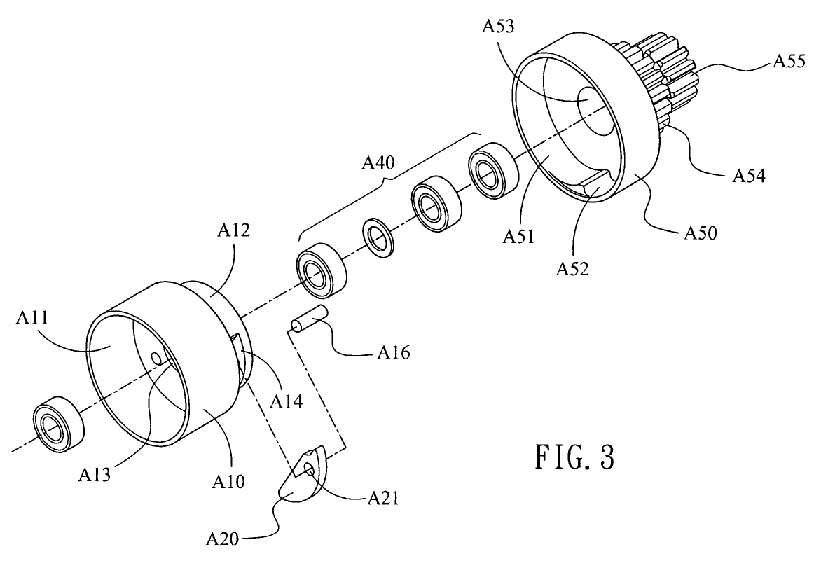

Referring to FIG. 1, the present invention is to have a flywheel stand 20 on the rolling axis 20 of the engine 10, as shown in FIG. 1, FIG. 2 and FIG. 3, some clutch part 30 are installed on the flywheel stand 20 and have a hood A covers these clutch part 30; the hood A consists of a first hood A10 and a second hood A50, the first hood A10 has a containing space A11 on the rear to contain and isolate the clutch part 30, a protruding ring A12 with smaller diameter is on the front of the first hood A10, an axis hole A13 for the turning axis 11 to pass through is on the center of the protruding ring A12, at least one side slot A14 around the protruding ring A12, a through hole A17 is on the proper location of the side slot A14; a protruding wheel A20 (rectangular is better) with a hole A21 is inside the side slot A14, an inserting pin A16 passes through the through hole A17 into the hole A21 of the protruding wheel A20 to make the protruding wheel A20 swing.

Referring to FIG. 2 and FIG. 3, the second hood A50 has a center hole A53 and a container A51 corresponding to the first hood A10 to cover the protruding ring A12 and other components, a stopper A52 is on the inner circumference of the container A51 of the second hood A50, two co-axial gear A54, A55 are in the front of the second hood A50.

Referring to FIG. 1, a fixing mechanism A60 is inserted from the front, passing through the axis hole A13 and the center hole A53 of the first hood A10 and the second hood A50 and fixed on the turning axis 11 of the engine 10.

Referring to FIG. 1, the turning axis 11 of the engine 10 is wrapped with the axis set A40 and then wrapped by the first hood A10 and the second hood A50.

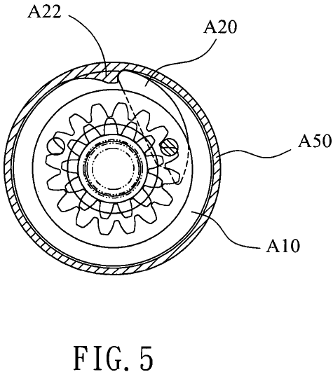

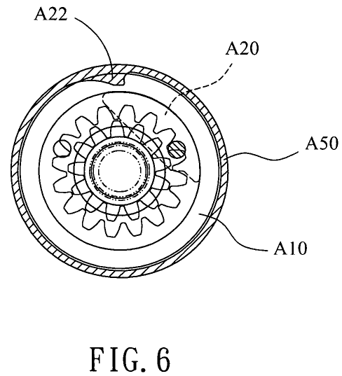

Referring to FIG. 1, FIG. 5 and FIG. 6, when the hood A comprised of the first hood A10 and the second hood A50 revolves, if the engine 10 is not fast enough, the protruding wheel A20, as shown in FIG. 6, will not function, when engine reaches to certain speed, as shown in FIG. 5, the protruding wheel A20 swings out by centrifugal force and props up the stopper 52 of the second hood A50, the second hood A50 is brought together and turns, the two co-axial gear A54, A55 turn along.

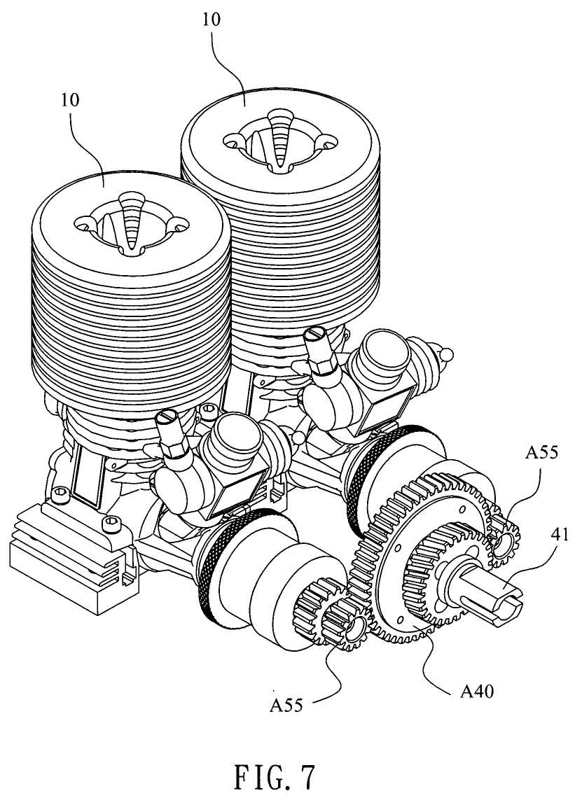

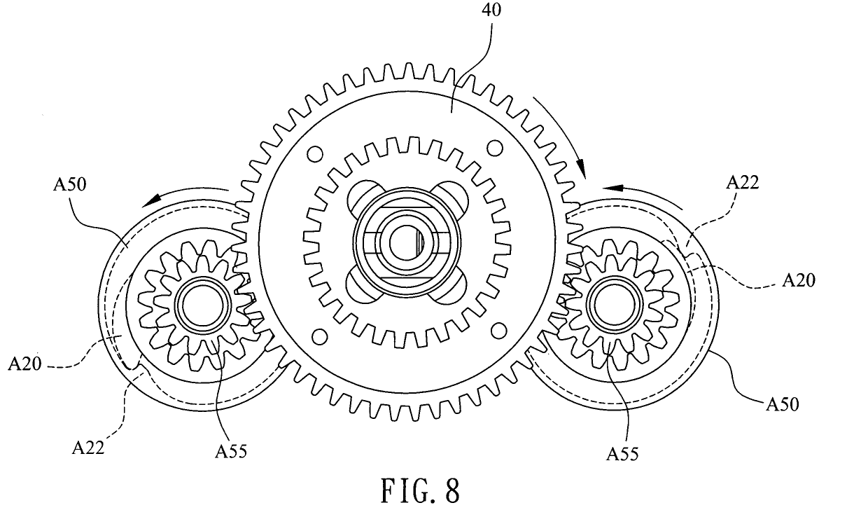

Referring to FIG. 7, the structure described above is suitable for twain engine 10, referring to FIG. 7 and FIG. 8, when both passive gear 40 are brought by the two co-axial gear A55, if one of them starts faster (as shown on the left of FIG. 8), the passive gear 40 is still pulled by other co-axial wheel A55 (as shown on the right of FIG. 8), the co-axial gear A55 on the right run at same speed with the co-axial gear A55 on the left and is faster than the engine 10 on the right, the stopper 52 of the second hood A50 will pass over the protruding wheel A20, the protruding wheel A20, as shown in FIG. 6, does not function, the second hood A50 is idle running, until the engine 10 runs at the same speed of the second hood A50, the protruding wheel A20 props up the second hood A50 and make two engines 10 run at the same speed.

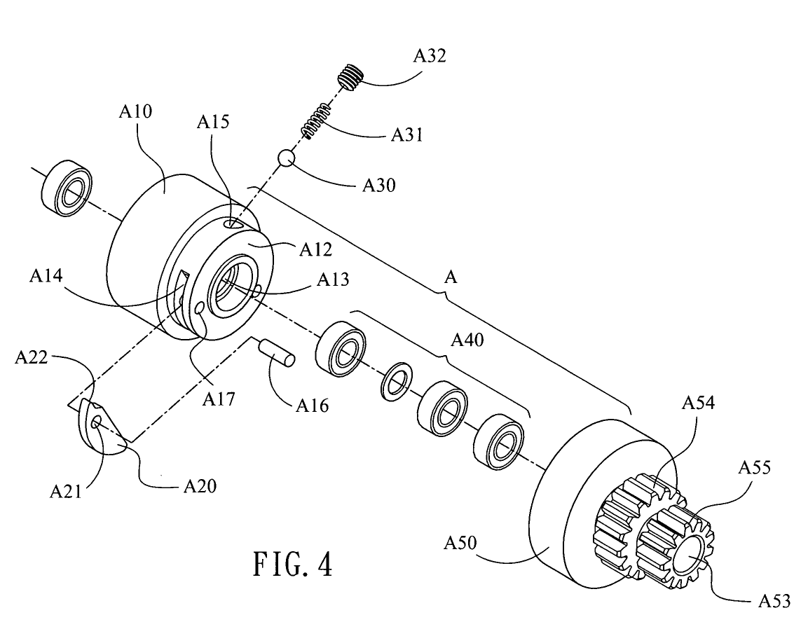

Referring to FIG. 4, a fastener A22 is installed near the hole A21 of the protruding wheel A20, the fastener A22 can be an indentation (as shown in FIG) or a protruding tenon, as long as the fastener A22 props up properly without sliding.

A lock hole A15 with threads is installed along the circumference the protruding ring A12 of the first hood A10; a lock ball A30, a spring A31 and a adjustable screw A32 are installed from inside to outside of the lock hole A15; the adjustable screw A32 can be loosened or tightened to adjust the spring A31 with proper strength to prop up the lock ball A30 to have the lock ball A30 push the protruding wheel A20 with proper push and adjust the time period that protruding wheel A20 swing out by centrifugal force, the stronger the strength the lock ball A30 pushes the protruding wheel, the higher speed needed to swing the protruding wheel A20 out, by contrary, the protruding wheel A20 is swung easier and works with other components, such mechanism can adjust the speed difference to have two engines 10 turn at same speed.

In view of the foregoing, the clutch of a twain engine remote control automobile according to the present invention has the following advantages:
1. The hood comprises of a first hood and a second hood with a protruding wheel swings freely inside, the transmission depends on the speeds of two engines, and is safer to apply on two engines without damaging engines and gears, the transmission gears will not impede each other to cause interference between two engines.
2. Based on above description, the present invention is safe and smooth to apply, the failure rate is very low to lower the repair and replace cost.

1. A clutch of a twain engine remote control automobile comprising:
a flywheel stand on the rolling axis of the engine, some clutch parts are installed on said flywheel stand and have a hood covers these clutch parts;
said hood consists of a first hood and a second hood, said first hood has a containing space on the rear to contain and isolate the clutch parts, a protruding ring with smaller diameter is on the front of said first hood, an axis hole for the turning axis to pass through is on the center of said protruding ring, at least one side slots around said protruding ring, a through hole is on the proper location of said side slot, a protruding wheel with a hole is inside said side slot, an inserting pin passes through said through hole into said hole of said protruding wheel to make said protruding wheel swing;
said second hood has a center hole and a container corresponding to said first hood to cover said protruding ring and other components, a stopper is on the inner circumference of said container of said second hood, two co-axial gears are in the front of said second hood;
a fixing mechanism is inserted from the front, passing through said axis hole and said center hole of said first hood and said second hood and fixed on the turning axis of the engine.

2. The clutch of a twain engine remote control automobile recited in claim 1, wherein said protruding wheel is in rectangular shape.

3. The clutch of a twain engine remote control automobile recited in claim 1, wherein a fastener installed near said hole of said protruding wheel.

4. The clutch of a twain engine remote control automobile recited in claim 3, wherein said fastener of said protruding wheel is a indentation

5. The clutch of a twain engine remote control automobile recited in claim 3, wherein said fastener of said protruding wheel is a protruding tenon.

6. The clutch of a twain engine remote control automobile recited in claim 1, wherein A lock hole with threads is installed along the circumference said protruding ring of said first hood, a lock ball, a spring and a adjustable screw are installed from inside to outside of said lock hole, said adjustable screw can be loosened or tightened to adjust said spring with proper strength to prop up said lock ball to have the lock ball push said protruding wheel with proper push said protruding wheel.

7. The clutch of a twain engine remote control automobile recited in claim 1, wherein the turning axis of the engine is wrapped with a axis set and then wrapped by said first hood and said second hood.
